(19) United States
(12) Patent Application Publication
(10) Pub. No.: US 2012/0303536 A1
(43) Pub. Date: Nov. 29, 2012

(54) Property complexity scoring system, method, and computer program storage device

(75) Inventors: Jon Wierks, Tustin, CA (US); Susan Allen, Irvine, CA (US)

(73) Assignee: Corelogic Information Solutions, Inc., Santa Ana, CA (US)

(21) Appl. No.: 13/067,330

(22) Filed: May 25, 2011

(51) Int. Cl. G06Q 50/00

(52) U.S. Cl. 705/306

(57) ABSTRACT

A property complexity scoring device includes an interface and a computer processor that is programmed to receive location information of a target property via the interface. The computer processor also receives respective property values of the target property from each of a plurality of Automated Valuation Models (AVMs) via the interface and calculates a complexity score based on a combination of the received property values. The complexity score is in one of a plurality of complexity score levels and indicates a difficulty level in determining a property value estimate of the target property. Another approach uses a reconciliation of a plurality of scoring processes to arrive at a complexity score.

### BACKGROUND

1. Technical Field

The disclosure relates to a property complexity scoring device and associated methodology and non-transitory computer program storage device for calculating a complexity score indicating a difficulty level in determining a property value estimate of a target property.

2. Description of the Related Art

When buying or selling property, it is often necessary to obtain an appraisal in order to determine a value estimate of the property. This value is then used in many ways when selling the property, such as how much a lender should loan to a prospective purchaser. A variety of options are available for obtaining appraisals, such as obtaining a manual appraisal from an appraiser, obtaining a Broker Price Opinion (BPO) or using Automated Valuation Models (AVMs). As recognized by the present inventor, appraisals by experienced appraisers can provide the most accurate evaluations of the property value, but are subject to bias and higher price point ranges for performing the evaluation. More junior examiners can provide acceptable results for a lesser price when fewer complicated factors are involved. BPOs may also be suitable in some instances, especially where there are a large number of close comparables for similarly situated properties. AVMs, depending on the availability of relevant data, can electronically provide accurate and unbiased appraisals immediately at a fraction of the cost by accessing a variety of property information stored in databases.

### SUMMARY

While the property value obtained by AVMs can be obtained quickly and cheaply, the accuracy of an AVM determination decreases based on the difficulty level in determining the property value estimate of a target property. For example, a “white elephant” property that is unique to the surrounding neighborhood and has unique physical features can be difficult to accurately evaluate electronically because of the lack of comparable information with respect to these unique features of the property. BPOs and less experienced appraisers may also struggle under these circumstances. Therefore, a lender may want to know whether a manual appraisal should be performed for the target property in addition to the AVM property valuation and what a typical cost of such an appraisal should be based on the difficulty level of determining the property value estimate. In addition, appraisal services or lenders who commission appraisers may want a better understanding of how difficult it will be to determine a value estimate of a property when directing appraisal orders. AVMs do not provide this important information.

The present disclosure describes a property complexity scoring device and associated methodology for determining a complexity score that provides a difficulty level in determining an accurate property value estimate of a target property. The property complexity score informs a user (often a lender) of many things, such as (1) what type of appraisal process should be performed to strike an accurate balance between accuracy and cost, (2) whether an additional appraisal should be performed and how much the appraisal should cost for the target property, and (3) to assist in determining a fair price for an appraisal, based on the complexity posed by the target property. Moreover, particular embodiments provides information on what type of appraisal, such as a manual appraisal or BPO, should be performed with respect to the target property, and appropriate experience level required for the handling the target property. Selecting the type of appraisal in this way allows for a cost-efficient appraisal that still yields reliable results.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the present advancements and many of the attendant advantages thereof will be readily obtained as the same becomes better understood by reference to the following detailed description when considered in connection with the accompanying drawings. However, the accompanying drawings and their exemplary depictions do not in any way limit the scope of the advancements embraced by the specification. The scope of the advancements embraced by the specification and drawings are defined by the words of the accompanying claims.

FIG. 1 is a schematic diagram of a system for determining a complexity score according to an exemplary embodiment;

FIG. 2 is a schematic flow diagram of a system for determining a complexity score according to an exemplary embodiment;

FIG. 3 is a system flowchart for determining a complexity score according to an exemplary embodiment;

FIG. 4 is an information flow diagram of a system for determining a complexity score according to an exemplary embodiment;

FIG. 5 is a flowchart for determining a specific complexity score based on a set of received parameters according to an exemplary embodiment; and

FIG. 6 is a schematic diagram of a complexity scoring device for determining a complexity score according to an exemplary embodiment.

### DETAILED DESCRIPTION OF THE EMBODIMENTS

Referring now to the drawings, wherein like reference numerals designate identical or corresponding parts throughout the several views, the following description relates to a device and associated methodology for determining a complexity score indicating a difficulty level in determining a property value estimate of a target property. Specifically, the property scoring device receives location information of a target property and property values of the target property from an interface. A complexity score is then calculated based on a combination of the received property values that were calculated using the location information. The complexity score falls in one of a plurality of complexity score levels and indicates a difficulty level in determining a property value estimate of the target property. The complexity score may then be used as input in selecting an appraisal process that is both cost-effective and accurate in light of the underlying circumstances.

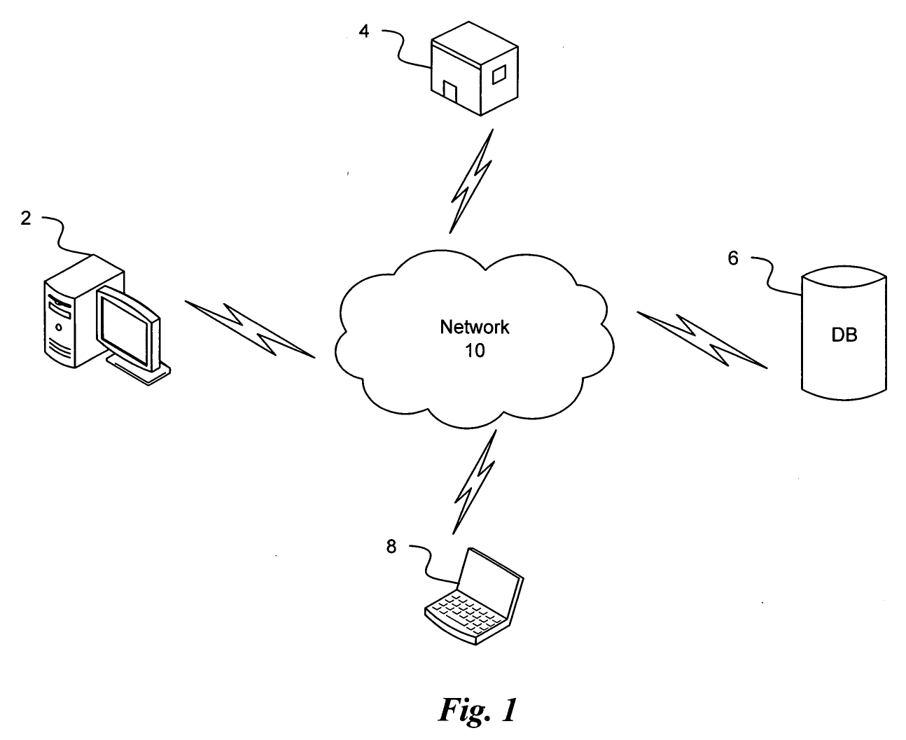

FIG. 1 is a schematic diagram of a system for determining complexity scores of target properties according to an exemplary embodiment. In FIG. 1, a computer 2 is connected to a server 4, a database 6 and a mobile device 8 via a network 10. The server 4 represents one or more servers connected to the computer 2, the database 6 and the mobile device 8 via the network 10. The database 6 represents one or more databases connected to the computer 2, the server 4 and the mobile device 8 via network 10. The mobile device 8 represents one or more mobile devices connected to the computer 2, the server 4 and the database 6 via the network 10. The network 10 represents one or more networks, such as the Internet, connecting the computer 2, the server 4, the database 6 and the mobile device 8.

The computer 2 includes an interface, such as a keyboard and/or mouse, allowing a user to input location information of the target property which is then transmitted to the server 4 via network 10. The location information typically includes address information but can include any type of location information, such as Geographic Information Systems (GIS) information and Global Positioning System (GPS) information, as would be recognized by one of ordinary skill in the art for identifying the location of a property. The location could be used to compare with grid coordinates and/or parcel data stored in a proprietary or public records database to identify a street address or MLS listing, or other parcel identifier.

Once the location information is received by the server 4, the server 4 uses the location information to query the database 6 via network 10 to determine a variety of characteristics relating to the target property, property market information, and conformity information of the target property with respect to a variety of surrounding properties. This information, along with any information manually input by the user at computer 2, is then used by the server 4 to calculate, as will be discussed, one or more property values and one or more forecast standard deviation (FSD) scores of the target property. FSD denotes confidence in an AVM estimate and uses a consistent scale and meaning to generate a standardized confidence metric. The FSD is a statistic that measures the likely range or dispersion an AVM estimate will fall within, based on the consistency of the information available to the AVM at the time of estimation.

Lower FSDs are better because it represents higher confidence in the AVM estimate. Because statistical certainty is rare, a confidence interval is used to indicate the level of statistical certainty associated with an FSD. In this case, a confidence interval of 68 percent is used, meaning that one can say with 68 percent statistical accuracy that the true value lies within the upper and lower values. If for example, an AVM returns an estimate of $100,000 with an FSD of 10, one can say with 68 percent statistical certainty that the value lies between $90,000 and $110,000. If the FSD is 30, one can say with 68 percent statistical certainty that the actual value will be somewhere between $70,000 and $130,000.

Although FSD scores are used as one measure of a statistical spread in the sample set, other measures may be used as well such as variance, median/mean/mode analytics, etc. The server 4 optionally checks for inconsistent information describing the target property to ensure that consistent characterization data is used in the appraisal process. If inconsistencies are observed, a flag or message is generated, noting the inconsistency, which can then used for subsequent verification of data consistency. The server 4 then transmits the property value information along with calculated FSD score (or other metric) information to the computer 2 for analysis.

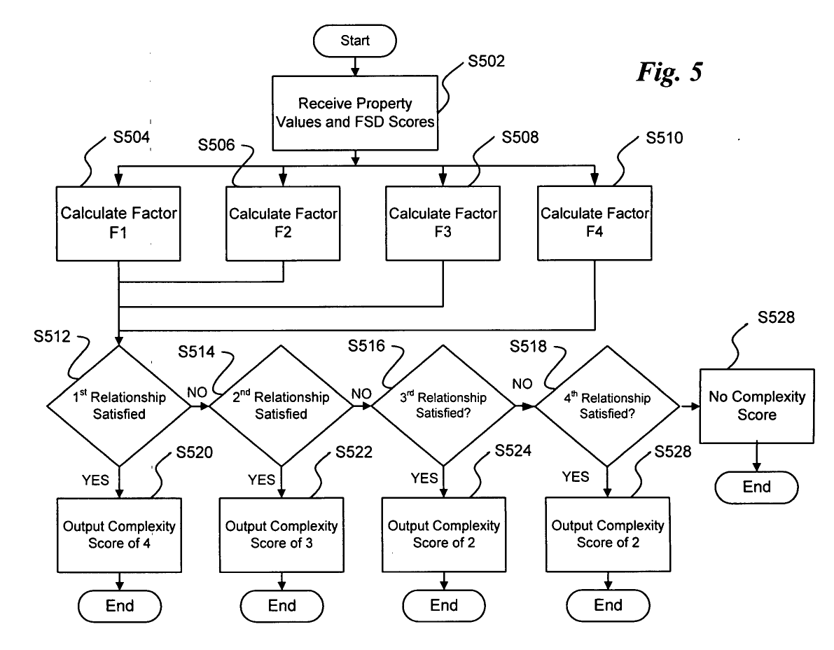

The computer 2 then calculates a complexity score identifying the difficulty level in determining an accurate property value estimate of the target property based on the received property values and FSD scores. A more detailed description of determining the complexity score is provided below in FIG. 5. Once the complexity score is calculated, it is saved in memory and then displayed on the display screen of computer 2 and can also be sent to a variety of external devices, such as a mobile device 8, via a text, e-mail, FACEBOOK, TWITTER or any other related method.

As would be understood by one of ordinary skill in the art, based on the teachings herein, the mobile device 8 or any other external device could also be used in the same manner as the computer 2 to calculate the complexity score by receiving property location information from an interface and sending the property location information to server 4 and database 6 via network 10 to obtain the one or more property values and FSD scores. In an exemplary embodiment a user, perhaps a lender, uses an application on his or her SmartPhone to geolocate a present position of the SmartPhone (presuming it is one the target property's premises) and receives a complexity score as a result. Since the complexity score relates to appraisal process, the application may also provide a recommended appraisal process and cost for performing that appraisal. Optionally, the SmartPhone may be used to request the appraisal automatically.

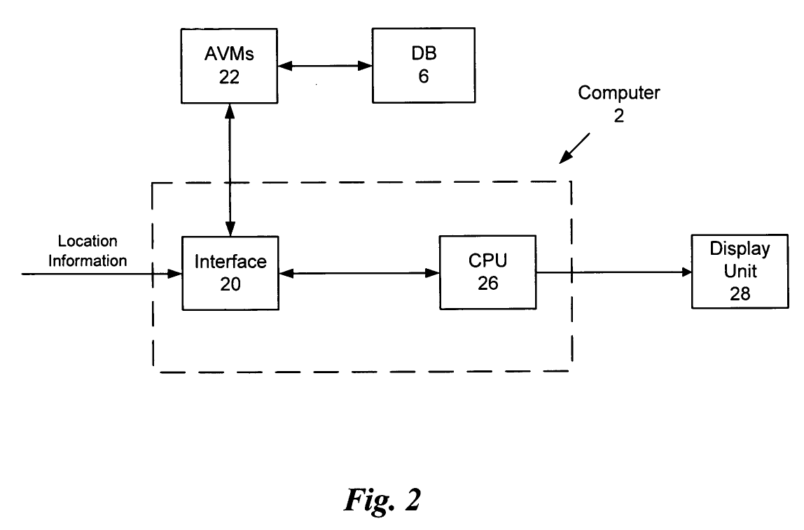

FIG. 2 is an information flow diagram of a system for determining a complexity score according to an exemplary embodiment. The computer 2, server 4 and database 6 of FIG. 1 are illustrated in FIG. 2 and therefore like designations are repeated. As illustrated in FIG. 2, location information is either generated internally through a GPS module or received by an interface 20 of the computer 2. Location information could be received by the interface 20 from a variety of devices such as a keyboard, mouse, touch screen, or externally through dictation or the Internet. The location information received by the interface 20 of computer 2 is then transmitted to the server 4. In one embodiment, the server 4 includes one or more AVMs 22 which determine the value of a target property based on a variety of property information obtained from the database 6. Property values and FSD scores from each AVM 22 of server 4 are transmitted to a central processing unit (CPU) of computer 2 which then calculates the complexity score based on a combination of the received property values and FSD scores. The complexity score is then provided to a user via a display unit 28 to help the user identify a difficulty level in determining a property value estimate of the target property.

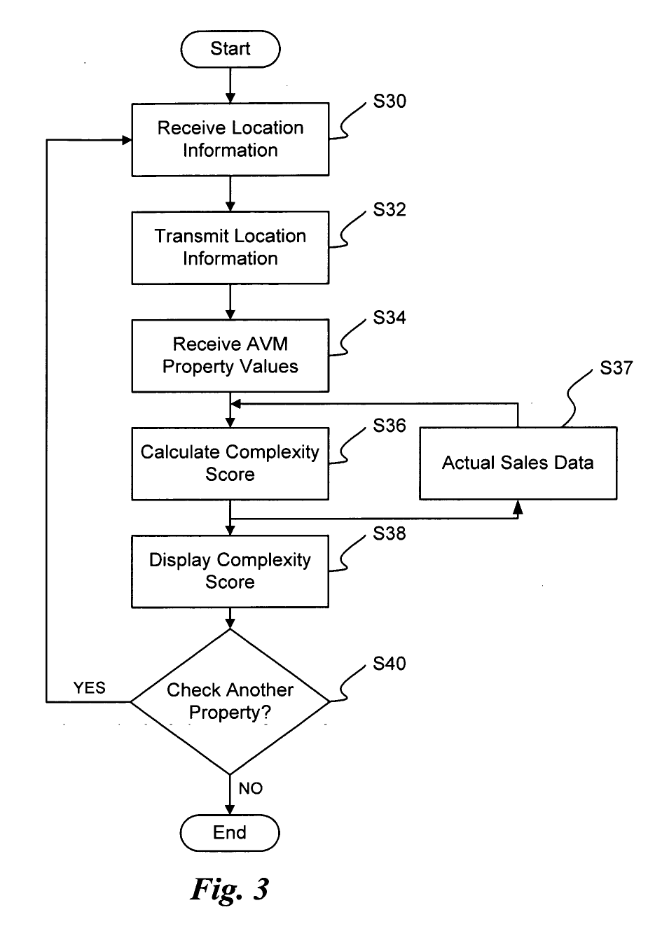

FIG. 3 is a flowchart illustrating the processing performed by the complexity scoring device when determining the complexity score indicating the difficulty level in determining a property value estimate of the target property. At step S30, location information identifying the target property is received from the interface 20. The location information is then transmitted to the server 4 via network 10 at step S32. As noted above, the server 4 contains the one or more AVMs 22, or is connected to one or more AVMs 22, which uses the location information to calculate property values and FSD scores of the target property. Example AVMs include HOME PRICE ANALYZER®, VALUEPOINT4®, PASS PROSPECTOR®, and PASS®.

The one or more AVMs 22 calculate property values and FSD scores based on a variety of property information. This information is obtained both manually from a user via interface 20 and from the one or more AVMs 22 of server 4 by accessing database 6 using the location information received by the interface 20 at step S30. Once the property information is obtained from, the AVMs 22 calculate the property values and FSD scores with respect to the target property. This information is then transmitted via network 10 and received by the computer 2 at step S34. Processing then proceeds to step S36 at which point the complexity score is calculated based on the received property values and FSD scores. The closer the property values and FSD scores are with respect to the different AVMs 22, the lower the difficulty level in determining the property value estimate of the target property. The calculation of the complexity score is described in further detail below with respect to FIG. 5. Once the complexity score is calculated, it is displayed on display unit 28 at step S36 to enable a user to see the difficulty level in determining the property value estimate of the target property.

Processing then proceeds to step S37 at which point the actual sales data of the target property is stored so that the data can be used to recursively improve the accuracy of the property complexity scoring. For example, if the target property values calculated by the AVMs do not closely correlate to the actual sales data, then the above-described property information used to determine the property value and property complexity score can be reevaluated based on the actual sales data to recursively perfect future complexity score outputs thereby providing more accurate information to help lenders direct appraisal orders. Once the user has obtained the complexity score for the target property, the user can then determine whether they would like to check another property in order to obtain a complexity score for that property at step S38. If the user is interested in determining the complexity score for another property at step S40, then processing proceeds back to step S30 and steps S30 through S38 are then repeated. Otherwise, the processing ends at step S40.

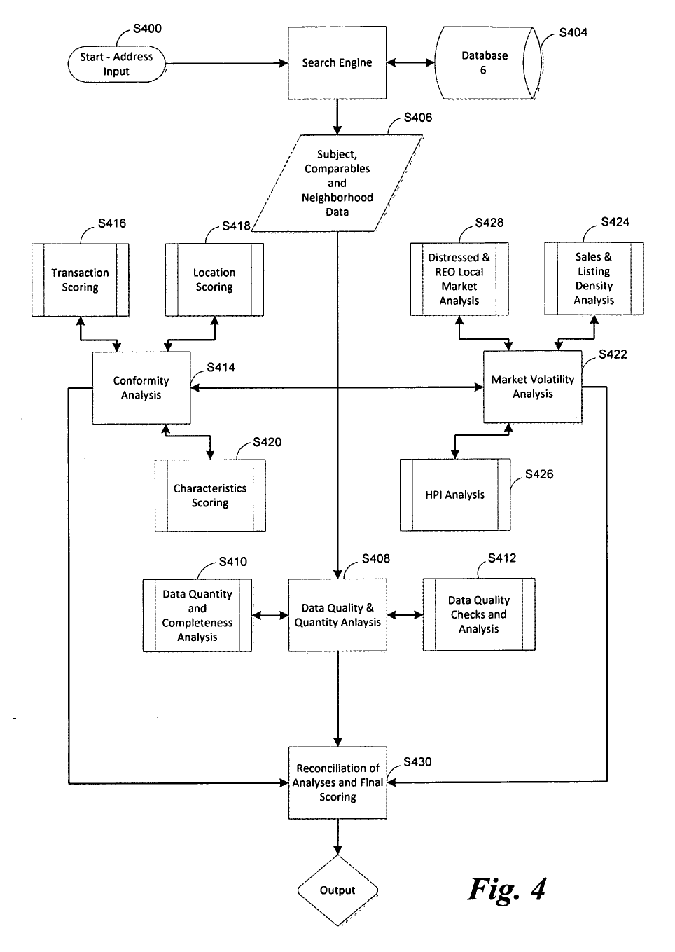

FIG. 4 is an information flow diagram describing a second embodiment of the complexity scoring device for determining a complexity score without using an AVM, at least not exclusively At step S400, location information identifying the target property, such as an address, or GPS data via a smartphone, is received at interface 20 and transmitted to a server 4 via network 10. The server 4 can include a search engine that receives the location information from the user at step S402 and queries the database 6 at step S404 using the location information. Based on the location of the target property, the search engine returns, at step S406, a variety of information falling into three categories: availability and accuracy information with respect to the target property, comparable information with respect to the target property and neighborhood market information. The property complexity scoring device then analyzes this information to calculate the difficulty level in determining a property value estimate for the target property. Analysis of the first category includes determining the availability and accuracy of the data obtained from the database 6 such as property characteristics, GIS information, sales transactions and listings of other properties. Exemplary information includes tax database records for the property, other public or private records databases that would include relevant information such as number of bedrooms, acreage, age, and past sales. Analysis of the second category includes analyzing information relating to the conformity of the target property versus the surrounding neighborhood. This would include information such as identifying differentials on the above characteristics with respect to closely located comparable properties. Analysis of the third category involves analyzing information relating to neighborhood market volatility.

At step S408, the complexity scoring device performs an analysis of the data quality and data quantity by looking at a variety of property information obtained from the database 6. The property information includes the actual location of each property, characteristics data, external factors which influence value, sales transaction history, and multiple listing service (MLS) listing information. Property characteristics of the target property include a variety of information about the physical aspects of the target property such as lot size, gross living area, bedroom count, bathroom count, number of stories, year built, garage description, heating, cooling, amenities such as a pool or spa, and the current condition of the property.

External factors relating to the GIS information can also have a positive or negative influence on a property value. For example, a property may be deemed more valuable based on its location with respect to waterfronts, mountains, oceans and golf courses based on the view and increased market value provided by these locations. However, the GIS information can also have negative influences on the property value based on its proximity to negatively rated property zones such as railroads, industrial zones and highways because of noise, pollution and other problems associated with these locations.

Sales transaction history includes information such as transfer types, price, date, loan amount, loan type, buyer names and seller names for each transfer of ownership of a property. It can also include title information and any contractual obligations surrounding the property such as easements and liens. The MLS listing information further indicates information about whether a property is currently for sale, the asking price, how long it has been for sale, and any changes to the asking price. In addition, the MLS data may also include property characteristic information and information regarding the current condition of the target property.

Once all of the property information is obtained from the database 6, a data quantity and completeness analysis is performed at step S410 to determine the availability of property information. For example, the property complexity scoring device may obtain information from the database 6 by querying the number of sales transactions that are available within a mile radius of the target property within the last 12 months. However, if the property complexity scoring device has to expand these search parameters then it will indicate a lower availability level of data which in turn indicates higher difficulty level in determining the property value estimate of the target property.

At step S412, the property complexity scoring device also analyzes the data quality of the property information obtained from the database 6. The data quality indicates the accuracy of the property information contained in each property record and whether all of the data fields are populated for each property record. For example, if important data fields of the target property are not accurate, such as the number of bedrooms, price, location, or any other factor as would be recognized by one of ordinary skill in the art, then the property complexity scoring device calculates a higher difficulty level in determining the property value estimate of the target property.

In addition to determining the data availability and quality, the property complexity scoring device performs a conformity analysis of the target property at step S414 with respect to conformity information of the target property versus the surrounding neighborhood as well as the availability of sales comparables. This information is obtained by searching for properties of the same use code type as the target property with recent sales transactions in the surrounding area. Therefore, at step S416, transaction scoring is performed to determine the nature of the neighborhood with respect to the target property. This will determine the distance and time search parameters appropriate for each target property. For example, in a typical suburban neighborhood with a stable real estate market, searching a one half mile radius for all sales transactions going back twelve months will generally provide sufficient results. However, in a rural setting, the search radius may need to be increased to several miles because of the large distances between neighboring properties. Further in a slow real estate market, the search may need to go back further in time to obtain the requisite amount of sales transactions. In other words, there must be enough available transactions and listings that are similar to the subject property so that they can be used as comparables information to determine the value of the target property.

As noted above, this type of sales transaction history includes information such as transfer types, price, date, loan amount, loan type, buyer names and seller names for each transfer of ownership of a property. It can also include title information and any contractual obligations surrounding the property such as easements and liens. The MLS listing information further indicates information about whether a property is currently for sale, the asking price, how long it has been for sale, and any changes to the asking price. In addition, the MLS data may also include property characteristic information and comments regarding current condition.

The conformity analysis also includes characteristics scoring, performed at step S420, to analyze the property characteristics of other houses surrounding the target property. For example, an ideal comparable is a property (or ideally multiple properties) next door to the target property that are identical in characteristics, identical in condition and sold recently in an arms-length transaction. However, this can be difficult to obtain when looking at a large amount of different property information such as location, characteristics and transaction information. Therefore, other information such as the distance of the target property from comparable properties, subdivisions data, external factors indicated by a GIS data, property characteristics and other related sales transactions are considered with respect to identifying useful conformity information.

At step S418, location scoring is also performed within the conformity analysis to provide surrounding property information for neighboring properties such as the external factors identified above. For example, the difficulty in determining the value of surrounding properties because of positive or negative influence factors such as views, golf courses, railroads, and highways can increase the difficulty in determining the property value estimate of the target property. Further, properties located in similar housing developments or preplanned rural developments can provide information that decreases the difficulty level in determining the property value estimate.

In addition to the conformity analysis, the property complexity scoring device also performs a market volatility analysis at step S422 to determine surrounding market conditions with respect to the target property. The volatility of the neighboring market or slow market conditions directly affect the difficulty level in determining a property value estimate of the target property. When performing the market analysis, a variety of information is identified that provides indicators of market conditions. For example, a sales and listing density analysis is performed at step S424 which identifies volatile market conditions when trend data indicates extremely high price differences for comparable properties whereas stable market conditions are identified when trend data indicates similar prices between comparable properties. Further, distressed and real estate owned (REO) sales are analyzed at step S428 to provide additional indicators of market volatility. For example, large percentages of distressed and REO sales points to a more volatile market. At step S426, home price indexes (HPI) are also analyzed to determine any indications of market volatility by showing a market's historical to current price trends with respect to properties in the neighborhood.

The above-described property information does not represent an exhaustive list of what can be considered when determining the property value and FSD score of the target property and can therefore include other types of property information relevant to such a determination as would be recognized by one of ordinary skill in the art. Once the analysis for each category is performed, the analysis results are reconciled and final scoring is performed at step S430 to output the complexity score for the target property at step S432.

FIG. 4 illustrates the process for this embodiment. In the AVM embodiment, the AVM models are performing these processes as part of their valuation. In the AVM this process is embedded in other valuation processes. FIG. 4 lays out the process as it would happen in a dedicated PCS model.

An example for step S430: Once the Conformity Analysis, Market Volatility Analysis and Data Quality & Quantity Analysis are completed, step S430 performs a reconciliation of the analyses and produces a final score. The weighting and exact scoring would be adjustable to accommodate vendor specific preferences. As an example, assume that each of the three analyses has a possible score of 0-100 and that each of the analyses is weighted equally (⅓). The reconciliation would be (S⅓)+(S⅔)+(S 3/3)=Final Overall Score. The final overall score is then converted into the PCS. The conversion factor would also be vendor specific, although it could be a linear multiplier or linear or non linear conversion, with multipliers and additive/subtractive offsets. Again for the example, assume that a final overall score of 1-25=1 PCS, 26-50=2 PCS, 51-75=3 PCS and 76-100=4 PCS. Using this example, if a particular property received a 75 Conformity, 60 Market Volatility and 90 Data Quality scores, the reconciliation would be as follows:
(75/3)+(60/3)+(90/3)=75 for a final PCS of 3.

FIG. 5 is a flowchart illustrating how the complexity score is calculated by the complexity scoring device. At step S502, one or more property values and FSD scores are received from the AVMs 22. At step S504, the average deviation of the property values and the median of the property values are calculated and the average deviation is divided by the calculated median to obtain a value representing a first factor F1. At step S506, the average deviation of the FSD scores is calculated to obtain a value representing a second factor F2. The median deviation of the FSD scores is also calculated to obtain a value represented by a third factor F3 at step S508. The number of successfully returned property values from the AVMs 22 is also determined as a fourth factor F4 at step S510. These steps may be performed simultaneously or in any order to obtain the factors F1-F4.

Once the four factors F1-F4 are calculated, processing proceeds to calculate the complexity score based on these factors. First, it is determined at step S512 whether the four factors satisfy a first relationship of (F1<=0.10) and (F2<5) and (F3<=15) and (F4>2). If this relationship is true, a complexity score of 4 is output to the display unit 28 at step S520 and processing ends. If the first relationship is not met, processing proceeds to step S514 where it is determined whether a second relationship is met. The second relationship is satisfied when (F1<=0.15) and (F2<5) and (F3<=19) and (F4>2) is true. If the second relationship is satisfied, processing proceeds to step S522 and a complexity score of 3 is output to the display unit 28. If the second relationship is not met, processing proceeds to step S516 where it is determined whether a third relationship is met. The third relationship is met when (F1<=0.24) and (F2<6) and (F3<=22) and (F4>1) is true. If the third relationship is satisfied, processing proceeds to step S524 and a complexity score of 2 is output to the display unit 28 at step S524. If the third relationship is not satisfied then processing proceeds to step S518 where it is determined whether a fourth relationship of (F1>0.24) or (F2>=6) or (F3>22) or (F4=1) is true. If the fourth relationship is satisfied, processing proceeds to step S526 and a complexity score of 1 is output to the display unit 28 and processing ends. If the fourth relationship is not met, processing proceeds to step S528 where it is determined that a property complexity score cannot be calculated at this time and a zero or null symbol is output to the display unit 28.

The above values for F1-F4 for the 4 relationships are merely exemplary. For the first relationship, the first factor may be compared with a value that ranges from 0.01 to 0.25; the second factor may be compared with a value that ranges from 2 to 10; the third factor may be compared with a value that ranges from 10 to 25; and the fourth factor may be compared with a value that ranges from 0.1 to 4. As for the second relationship, the comparison values may range between 0.1 to 0.30 for the first factor; 2 to 10 for the second factor; 15 to 25 for the third factor; and 0.1 to 4 for the fourth factor. As for the third relationship, the comparison values may range between 0.2 and 0.4 for the first factor; 2 to 10 for the second factor; 20 to 25 for the third factor; and 0.1 to 2 for the fourth factor. As for the fourth relationship, the comparison values may range between 0.2 and 0.4 for the first factor; 2 to 10 for the second factor; 20 to 25 for the third factor; and 0.1 to 2 for the fourth factor.

Having described how the complexity scores are calculated and output by the complexity scoring device, it will now be discussed how the complexity scores relate to the difficulty in determining a property value estimate of a target property and to indicating a type of appraisal to be performed on the target property. First, it should be noted that the complexity scores are sorted in ascending order such that a lower complexity score represents that it is easier to determine the property value estimate of the target property and a higher complexity score represents that it is more difficult to determine the property value estimate of a target property. However, as would be recognized by one of ordinary skill in the art and in light of the present teachings, any order can be applied when identifying the difficulty level in determining the property value estimate of the target property. The complexity scores can also be represented by symbols, alphanumeric characters or any other identifying mark as would be understood by one of ordinary skill in the art.

A complexity score of 4 is the least complex to value accurately and represents that there is a large quantity of recent sales that are closely conforming to the target property. Further, it represents that the market is generally stable and that there is a large amount of available and accurate data. For example, a complexity score of 4 could mean that most or all of the relevant characteristic data fields are populated and that the property is most likely a tract home in a stable conforming neighborhood. A complexity score of 4 could then be used by an executive appraiser to determine that a junior appraiser is all that is necessary to perform a property appraisal without expending the resources and money required by an experienced appraiser. A complexity score of 4 can also save in appraisal fees as it indicates that a manual appraisal may not required as the property value calculated from the abundance of available data is accurate enough. However, should a user decide to do a separate manual appraisal, the complexity score of 4 will identify an appropriate price point for such a manual appraisal.

A complexity score of 3 represents that the target property may be more difficult to value than when a complexity score of 4 is issued but that the target property is still relatively easy to appraise and the property value is fairly accurate. For example, a complexity score of 3 can represent that there are available sales comparables but that they are less in quantity and less recent than those that would be required for a complexity score of 4 to be issued. Further, the neighborhood may have more price modes, the data may not be as available or accurate, and the market conditions may not be as stable. An appraiser (or lender) seeing a complexity score of 3 may be inclined to direct appraisal orders to someone with more experience than an entry level appraiser. Further, a lender seeing a complexity score of 3 may feel somewhat confident in the property value received from the AVM but may also consider obtaining a BPO on the target property to get a more accurate appraisal.

Properties receiving a complexity score of 2 will be lacking in at least one of the rating categories such as the availability of data including property characteristics, MLS information and sales transaction listings, the conformity of the subject property versus surrounding neighborhood and available sales comparables, and the volatility of the neighborhood market. For example, while the market may be extremely stable and there is available and accurate data with respect to the property characteristics, there may not be much information with respect to comparable properties in the surrounding neighborhood of the target property. As such, sales comparables may be light, there may be a wide range of price modes, and data characteristics may also be missing or light. Further, properties in this category could be under or over improvements for the neighborhood and the property may be in an area where some of the properties are affected by a view, waterfront or other external features. Further, as previously stated, the prices in the neighborhood may be extremely volatile and hard to track. Therefore, a complexity score of 2 identifies that an appraiser with at least a moderate amount of experience may be required when performing a manual appraisal of the target property. Further, the complexity score of 2 identifies to a lender that they may want to consider getting a standard manual appraisal while also providing the lender with a reasonable price point of what the standard manual appraisal should cost.

A complexity score of 1 identifies that the target property is the most complex to value in that it has serious shortcomings in the multiple rating categories listed above. For example, properties in this category includes unique properties such as “white elephant properties,” properties located in rural areas and/or very high end custom areas that are difficult to value. In addition, properties with poor sales comparable data or serious characteristic data deficiencies are also be included in this category. Therefore, a complexity score of 1 informs an appraiser that any appraisal orders with respect to the target property should be transferred to an appraiser with a high level of experience in evaluating properties of this type. Further, the complexity score of 1 informs a lender that a separate special request manual appraisal should be performed on the target property and that the cost of such a manual appraisal will be high as compared to target properties receiving lower complexity scores.

Although complexity scores 1-4 are discussed above, fewer or more complexity scores could be used to define the difficulty in determining a property value estimate of the target property. Further, complexity scores can be provided on a sliding scale thereby providing the user of the complexity scoring device with an idea of how strongly the complexity score relates to the difficulty in determining the property value estimate of the target property. For example, a complexity score that is between levels 2 and 3 but very close to level 3 may indicate to a user that the AVMs scores represent a fairly accurate depiction of the target property value whereas a complexity score closer to 2 may indicate that a BPO or manual appraisal should be obtained for the target property.

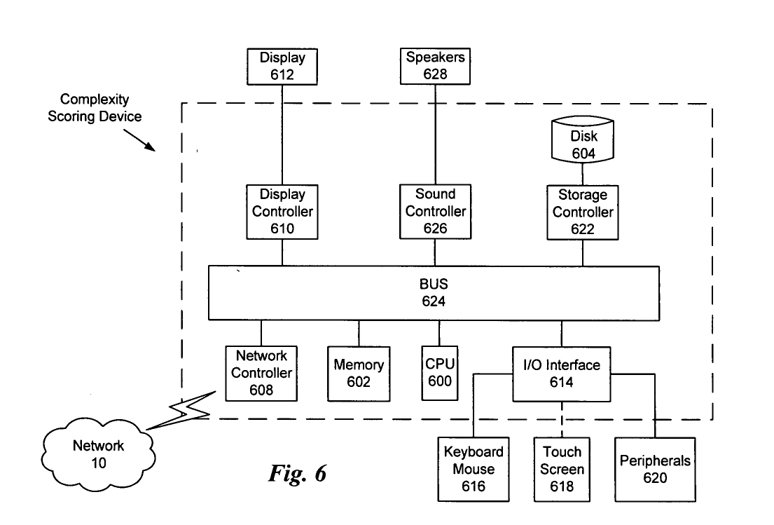

Next, a hardware description of the complexity scoring device according to exemplary embodiments is described with reference to FIG. 6. In FIG. 6, the complexity scoring device includes a CPU 600 which performs the processes described above. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer aided design station communicates, such as a server or computer.

Further, the claimed advancements may be provided as a utility application, background daemon, or component of an operating system, or combination thereof, executing in conjunction with CPU 600 and an operating system such as Microsoft Windows 7, UNIX, Solaris, LINUX, Apple MAC-OS and other systems known to those skilled in the art.

CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The complexity scoring device in FIG. 6 also includes a network controller 608, such as an Intel Ethernet PRO network interface card from Intel Corporation of America, for interfacing with network 10. As can be appreciated, the network 10 can be a public network, such as the Internet, or a private network such as an LAN or WAN network, or any combination thereof and can also include PSTN or ISDN sub-networks. The network 10 can also be wired, such as an Ethernet network, or can be wireless such as a cellular network including EDGE, 3G and 4G wireless cellular systems. The wireless network can also be WiFi, Bluetooth, or any other wireless form of communication that is known.

The complexity scoring device further includes a display controller 610, such as a NVIDIA GeForce GTX or Quadro graphics adaptor from NVIDIA Corporation of America for interfacing with display 612, such as a Hewlett Packard HPL2445w LCD monitor. A general purpose I/O interface 614 interfaces with a keyboard and/or mouse 616 as well as a touch screen panel 618 on or separate from display 612. General purpose I/O interface also connects to a variety of peripherals 620 including printers and scanners, such as an OfficeJet or DeskJet from Hewlett Packard.

A sound controller 626 is also provided in the complexity scoring device, such as Sound Blaster X-Fi Titanium from Creative, to interface with speakers/microphone 628 thereby providing sounds and/or music. The speakers/microphone 628 can also be used to accept dictated words as commands for controlling the complexity scoring device or for providing location and/or property information with respect to the target property.

The general purpose storage controller 622 connects the storage medium disk 604 with communication bus 624, which may be an ISA, EISA, VESA, PCI, or similar, for interconnecting all of the components of the complexity scoring device. A description of the general features and functionality of the display 612, keyboard and/or mouse 616, as well as the display controller 610, storage controller 622, network controller 608, sound controller 626, and general purpose I/O interface 614 is omitted herein for brevity as these features are known.

Any processes, descriptions or blocks in flowcharts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order depending upon the functionality involved.

Obviously, numerous modifications and variations of the present advancements are possible in light of the above teachings. It is therefore to be understood that within the scope of the appended claims, the present advancements may be practiced otherwise than as specifically described herein.

1. A property complexity scoring device, comprising:
an interface; and
a computer processor programmed to
receive location information of a target property via the interface,
receive comparable property data and neighborhood data for the target property,
perform a data quality and quantity analysis on the comparable property data and neighborhood data,
perform a data conformity analysis on the comparable property data and neighborhood data,
perform a market volatility analysis on the comparable property data and neighborhood data,
perform a reconciliation analysis on results of the data quality and quantity analysis, conformity analysis, and market volatility analysis, said reconciliation analysis includes calculating a complexity score based on a result of the reconciliation analysis, wherein
the complexity score being one of a plurality of complexity score levels and indicating a difficulty level in determining a property value estimate of the target property.

2. The property complexity scoring device of claim 1, wherein
said reconciliation analysis calculates the complexity score based on a linear combination of results of said quality and quantity analysis, conformity analysis, and market volatility analysis.

3. The property complexity scoring device of claim 2, wherein said linear combination being an average.

4. A property complexity scoring device, comprising:
an interface;
a computer processor programmed to
receive location information of a target property via the interface;
receive respective property values of the target property from each of a plurality of Automated Valuation Models (AVMs) via the interface; and
calculate a complexity score based on a combination of the received property values, the complexity score being one of a plurality of complexity score levels and indicating a difficulty level in determining a property value estimate of the target property.

5. The property complexity scoring device according to claim 4, wherein the property value is calculated based on data including property identification information, neighborhood market volatility information, and conformity information of the target property with respect to a plurality of surrounding properties.

6. The property complexity scoring device according to claim 5, wherein the property identification information includes physical descriptions of the target property, external factors that can influence the property value of the target property, a sales transaction history of the target property, and Multiple Listing Service (MLS) information.

7. The property complexity scoring system according to claim 5, wherein the neighborhood market volatility information includes price differences between comparable properties, a number of Real Estate Owned (REO) sales, a number of recent property sales with respect to a density of a surrounding area, and Home Price Indexes (HPI).

8. The property complexity scoring device according to claim 5, wherein the conformity information includes, for each surrounding property of a surrounding neighborhood of the target property, location information, physical descriptions of the surrounding property, a sales transaction history of the surrounding property, and MLS information.

9. The property complexity scoring device according to claim 4, wherein a higher complexity score indicates a higher difficulty level in determining the property value estimate of the target property.

10. The property complexity scoring device according to claim 4, wherein said computer processor is further programmed to
receive a Forecast Standard Deviation (FSD) score for each received property value, and
calculate the complexity score based on four factor values, a first factor value (F1) being an average deviation of the property values divided by a median of the property values, a second factor value (F2) being an average deviation of the FSD scores, a third factor value (F3) being a median of the FSD scores, and a fourth factor value (F4) being the number of property values successfully calculated by the AVMs.

11. The property complexity scoring device according to claim 10, wherein
the plurality of complexity score levels includes levels 1 through 4,
a higher complexity score indicates a lower difficulty level in determining the property value estimate of the target property, and
the determination unit calculates a complexity score level of
4 when (F1<=0.10) and (F2<5) and (F3<=15) and (F4>2),
3 when (F1<=0.15) and (F2<5) and (F3<=19) and (F4>2),
2 when (F2<=0.24) and (F2<6) and (F3<=22) and (F4>1), and
1 when (F1>0.24) or (F2>=6) or (F3>22) or (F4=1).

12. The property complexity scoring device according to claim 4, wherein the complexity score further indicates a recommended type of appraisal to be performed on the target property.

13. The property complexity scoring device according to claim 12, wherein
a first complexity score level indicates the property values received from the AVMs as the recommended type of appraisal,
a second complexity score level indicates a broker price opinion (BPO) as the recommended type of appraisal,
a third complexity score level indicates a standard manual appraisal as the recommended type of appraisal, and
a fourth complexity score level indicates a special request manual appraisal as the recommended type of appraisal.

14. The property complexity scoring device according to claim 4, wherein similar property values received from the AVMs indicates a lower difficulty level in determining a property value estimate of the target property, and
dissimilar property values received from the AVMs indicates a higher difficulty level in determining a property value estimate of the target property.

15. A method for determining a complexity score of a target property, comprising:
receiving location information of a target property via an interface;
receiving respective property values of the target property from each of a plurality of Automated Valuation Models (AVMs) via the interface;
calculating, with a CPU, a complexity score based on a combination of the received property values, the complexity score being one of a plurality of complexity score levels and indicating a difficulty level in determining a property value estimate of the target property.

16. The method according to claim 15, further comprising:
receiving a Forecast Standard Deviation (FSD) score for each received property value, and
calculating the complexity score based on four factor values, a first factor value (F1) being an average deviation of the property values divided by a median of the property values, a second factor value (F2) being an average deviation of the FSD scores, a third factor value (F3) being a median of the FSD scores, and a fourth factor value (F4) being the number of property values successfully calculated by the AVMs.

17. The method according to claim 16, wherein
the plurality of complexity score levels includes levels 1 through 4,
a higher complexity score indicates a lower difficulty level in determining the property value estimate of the target property, and
the determination unit calculates a complexity score level of
4 when (F1<=0.10) and (F2<5) and (F3<=15) and (F4>2),
3 when (F1<=0.15) and (F2<5) and (F3<=19) and (F4>2),
2 when (F2<=0.24) and (F2<6) and (F3<=22) and (F4>1), and
1 when (F1>0.24) or (F2>=6) or (F3>22) or (F4=1).

18. The method according to claim 15, wherein the complexity score further indicates a recommended type of appraisal to be performed on the target property.

19. A non-transitory computer-readable medium storing computer readable instructions thereon that when executed by a computer processor cause the computer processor to perform a method for determining a complexity score of a target property, comprising:
receiving location information of a target property via an interface;
receiving respective property values of the target property from each of a plurality of Automated Valuation Models (AVMs) via the interface;
calculating, with the computer processor, a complexity score based on a combination of the received property values, the complexity score being one of a plurality of complexity score levels and indicating a difficulty level in determining a property value estimate of the target property.

20. The non-transitory computer-readable medium according to claim 19, further comprising:
receiving a Forecast Standard Deviation (FSD) score for each received property value, and calculating the complexity score based on four factor values, a first factor value (F1) being an average deviation of the property values divided by a median of the property values, a second factor value (F2) being an average deviation of the FSD scores, a third factor value (F3) being a median of the FSD scores, and a fourth factor value (F4) being the number of property values successfully calculated by the AVMs.

21. The non-transitory computer-readable medium according to claim 20, wherein the plurality of complexity score levels includes levels 1 through 4, a higher complexity score indicates a higher difficulty level in determining the property value estimate of the target property, and the determination unit calculates a complexity score level of
4 when (F1<=0.10) and (F2<5) and (F3<=15) and (F4>2),
3 when (F1<=0.15) and (F2<5) and (F3<=19) and (F4>2),
2 when (F2<=0.24) and (F2<6) and (F3<=22) and (F4>1), and
1 when (F1>0.24) or (F2>=6) or (F3>22) or (F4=1).

22. The non-transitory computer-readable medium according to claim 19, wherein the complexity score further indicates a recommended type of appraisal to be performed on the target property.
